(19) United States
(12) Patent Application Publication
(10) Pub. No.: US 2026/0086622 A1
(43) Pub. Date: Mar. 26, 2026

(54) COMPUTING POWER SCHEDULING METHOD, WEARABLE DEVICE, AND STORAGE MEDIUM, AND COMPUTER PROGRAM PRODUCT

(71) Applicant: GUANGDONG OPPO MOBILE TELECOMMUNICATIONS CORP. LTD., Dongguan (CN)

(72) Inventor: Wei Lv, Dongguan (CN)

(73) Assignee: GUANGDONG OPPO MOBILE TELECOMMUNICATIONS CORP. LTD., Dongguan (CN)

(21) Appl. No.: 19/342,317

(22) Filed: Sep. 26, 2025

Related U.S. Application Data
(63) Continuation of application No. PCT/CN2024/084858, filed on Mar. 29, 2024.

(30) Foreign Application Priority Data
Mar. 30, 2023 (CN) 202310336160.2

(51) Int. Cl. G06F 1/329; G06F 1/16; G06F 1/3293

(52) U.S. Cl. CPC G06F 1/329; G06F 1/163; G06F 1/3293

(57) ABSTRACT

A computing power scheduling method, a wearable device, and a storage medium are provided. The computing power scheduling method includes: when a first core obtains a first task, determining whether a computing power required by the first task exceeds a computing power range of the first core; when the computing power required by the first task exceeds the computing power range of the first core, determining a target computing power provider according to the computing power required by the first task, the computing power ranges of the N cores, and a computing power range of an electronic device, wherein the computing power required by the first task falls within a computing power range of the target computing power provider, and the target computing power provider is at least one of the electronic device and the N cores; and processing the first task by using the target computing power provider.

### CROSS REFERENCE TO RELATED APPLICATIONS

This application is a continuation of International Patent Application No. PCT/CN2024/084858, filed Mar. 29, 2024, which claims the priority of Chinese Patent Application No. 202310336160.2, filed Mar. 30, 2023, and entitled “computing power scheduling method, computing power scheduling apparatus, wearable device, and storage medium”, both of which are herein incorporated by reference in their entireties.

### TECHNICAL FIELD

The present disclosure relates to the field of wearable device technologies, and in particular relates to a computing power scheduling method, a computing power scheduling apparatus, a wearable device, a storage medium, and a computer program product.

### BACKGROUND

With technology advancement, wearable devices such as smart watches, smart bracelets, or the like may have more and more functions. For example, these functions may include sports health, information reminding, interaction with users, or the like. However, due to limited hardware resources of wearable devices, the computing capability of wearable devices may be restricted.

### SUMMARY

According to a first aspect of the present disclosure, a computing power scheduling method may be provided. The method may be applied to a wearable device. The wearable device may include N cores. N may be an integer greater than or equal to 2. The wearable device may establish a communication connection with an electronic device. The method may include: in a case where a first core obtains a first to-be-processed task, determining whether the computing power required by the first to-be-processed task exceeds the computing power range of the first core, the first core being any one of the N cores; in a case where the computing power required by the first to-be-processed task exceeds the computing power range of the first core, determining a target computing power provider based on the computing power required by the first to-be-processed task, the computing power ranges of the N cores, and the computing power range of the electronic device, wherein the computing power required by the first to-be-processed task may fall within the computing power range of the target computing power provider, and the target computing power provider may be at least one of the N cores and the electronic device; processing the first to-be-processed task by using the target computing power provider.

According to a second aspect of the present disclosure, a wearable device may be provided. The wearable device may include a processor and a memory. The processor may include N cores. N may be an integer greater than or equal to 2. The memory may be configured to store a computer program. The computer program may include program instructions. A first core may be configured to call the program instructions to execute a computing power scheduling method. The wearable device may establish a communication connection with an electronic device. The method may include: in a case where a first core obtains a first to-be-processed task, determining whether the computing power required by the first to-be-processed task exceeds the computing power range of the first core, the first core being any one of the N cores; in a case where the computing power required by the first to-be-processed task exceeds the computing power range of the first core, determining a target computing power provider based on the computing power required by the first to-be-processed task, the computing power ranges of the N cores, and the computing power range of the electronic device, wherein the computing power required by the first to-be-processed task may fall within the computing power range of the target computing power provider, and the target computing power provider may be at least one of the N cores and the electronic device; processing the first to-be-processed task by using the target computing power provider.

According to a third aspect of the present disclosure, a computer-readable storage medium may be provided. The computer-readable storage medium may store a computer program for electronic data exchange. The computer program may enable the first core to execute a computing power scheduling method applied to a wearable device. The wearable device may include N cores. The first core may be any of the N cores. N may be an integer greater than or equal to 2. The wearable device may establish a communication connection with an electronic device. The method may include: in a case where a first core obtains a first to-be-processed task, determining whether the computing power required by the first to-be-processed task exceeds the computing power range of the first core; in a case where the computing power required by the first to-be-processed task exceeds the computing power range of the first core, determining a target computing power provider based on the computing power required by the first to-be-processed task, the computing power ranges of the N cores, and the computing power range of the electronic device, wherein the computing power required by the first to-be-processed task may fall within the computing power range of the target computing power provider, and the target computing power provider may be at least one of the N cores and the electronic device; processing the first to-be-processed task by using the target computing power provider.

### BRIEF DESCRIPTION OF THE DRAWINGS

In order to more clearly illustrate technical schemes of the present disclosure or prior art, the drawings required in the description of the embodiments or the prior art would be briefly introduced below. Obviously, the drawings in the following description are only some embodiments of the present disclosure. For those of ordinary skills in the art, other drawings could be obtained based on these drawings without creative efforts.

FIG. 1 is a schematic view of a connection relationship between a wearable device and an electronic device according to an embodiment of the present disclosure.

FIG. 2 is a schematic flowchart of a computing power scheduling method according to an embodiment of the present disclosure.

FIG. 3 is a schematic flowchart of another computing power scheduling method according to another embodiment of the present disclosure.

FIG. 4 is a schematic flowchart of another computing power scheduling method according to another embodiment of the present disclosure.

FIG. 5 is a schematic diagram of computing power allocation in a triangular system according to an embodiment of the present disclosure.

FIG. 6 is a schematic diagram of computing power issuance in a triangular system according to an embodiment of the present disclosure.

FIG. 7 is a schematic diagram of computing power scheduling in a triangular system according to an embodiment of the present disclosure.

FIG. 8 is a schematic structural view of a computing power scheduling apparatus according to an embodiment of the present disclosure.

FIG. 9 is a schematic structural view of a wearable device according to an embodiment of the present disclosure.

### DETAILED DESCRIPTION

Technical schemes in embodiments of the present disclosure will be described clearly and thoroughly in connection with accompanying drawing of the embodiments of the present disclosure. Obviously, the described embodiments are only a part of the embodiments, but not all of them. All other embodiments by a person of ordinary skills in the art based on embodiments of the present disclosure without creative efforts shall all be within the protection scope of the present disclosure.

The terms “first”, “second” or the like in the specification, the claim set, and the figures in the present disclosure are used for distinguishing between different objects, and are not used intended for describing a particular sequential order. In addition, the terms “include”, “comprise” and any variations thereof may be intended to cover non-exclusive inclusion. For example, a process, a method, a system, a product, or a device that includes a series of operations or units may be not limited to the listed operations or units, but may optionally include unlisted operations or units, or optionally also includes other operations or units inherent to these processes, methods, products or devices.

Reference to “embodiments” herein means that, a specific feature, structure, or characteristic described in conjunction with the embodiments may be included in at least one embodiment of the present disclosure. The appearance of this phrase in various locations in the specification does not necessarily refer to a same embodiment, nor is it an independent or alternative embodiment mutually exclusive with another embodiment. Those skilled in the art may explicitly and implicitly understand that, the embodiments described herein may be combined with other embodiments.

The electronic devices involved in the embodiments of the present disclosure may include various computing devices with communication functions, vehicle-mounted devices, other processing devices connected to wireless modems, and various forms of user equipment (UE), mobile stations (MS), terminal devices, or the like. For ease of description, the devices mentioned above may be collectively referred to as electronic device.

The wearable devices involved in the embodiments of the present disclosure may include smart watches, smart bracelets, smart headsets, smart glasses, and other devices that may be conveniently worn on users.

As illustrated in FIG. 1, FIG. 1 is a schematic diagram of a connection relationship between a wearable device and an electronic device according to an embodiment of the present disclosure. As illustrated in FIG. 1, the wearable device 100 may include N cores. The N cores may such as core 1, core 2 . . . core N in FIG. 1. N is an integer greater than or equal to 2. The N cores may correspond to N computing power providers, also referred to as the computility providers (CP). The electronic device 200 may correspond to 1 CP.

Each of the N cores and the electronic device may provide different computing power. Generally speaking, compared with the N cores, the electronic device 200 may provide higher-level computing power.

The wearable device 100 and the electronic device 200 may establish a wireless communication connection or a wired communication connection. The wireless communication connection may for example be a Bluetooth connection, a Wi-Fi connection, or the like. The wired communication may for example be a data cable connection.

The wearable device 100 may support operation of a plurality of operating systems. For example, the N cores may run on P operating systems respectively. P is an integer less than or equal to N, and greater than or equal to 2. For example, the wearable device 100 may support two operating systems: an Android system and a real-time operating system (RTOS). Some of the N cores may run on the Android system, and another part of the N cores may run on the RTOS system. If N=2, one core may run on the Android system, and another core may run on the RTOS system. If N=4, one core may run on the Android system, and other three cores may run on the RTOS system.

In some embodiments, the wearable device 100 may operate in a single system. For example, the wearable device 100 may operate in a pure Android system or a pure RTOS system, so as to be compatible with different operating modes. The wearable device 100 may switch between the pure Android system and the pure RTOS system to switch operating modes.

In some embodiments, the wearable device 100 may operate in a dual-system mode. For example, the wearable device 100 may run the Android system and the RTOS system simultaneously. With coordinated operation of the dual systems, the wearable device 100 may have more powerful functions, and may enhance user experience of the wearable device 100. The wearable device 100 may switch between the single-system mode and the dual-system mode. For example, in the mode where the dual systems run coordinately, functions of the wearable device 100 may be enhanced, and the user experience of the wearable device 100 may be increased. In the pure RTOS system mode, power consumption of the wearable device 100 may be reduced, and a battery life of the wearable device 100 may be increased.

In the pure RTOS system mode, the functions of the wearable device such as sports, notification, tool functions, or the like may all be available, but an embedded subscriber identity module (eSIM) of the wearable device 100 may be turned off.

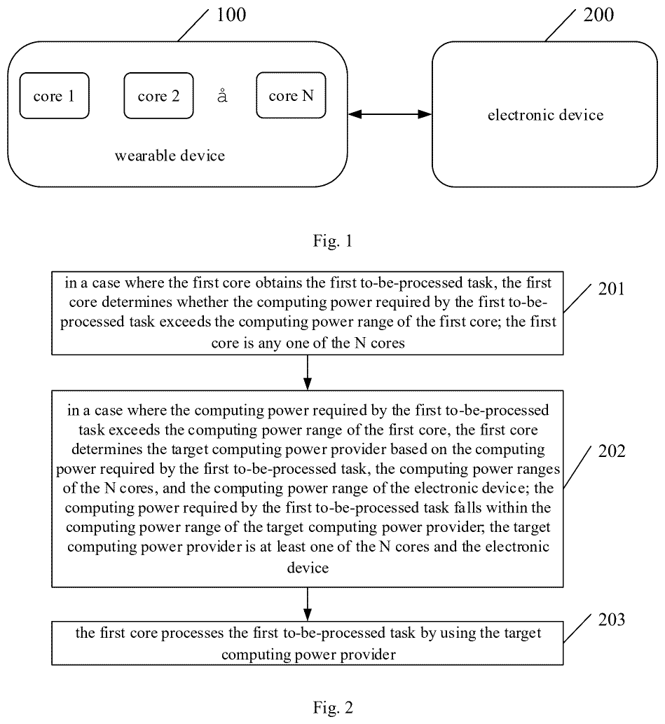

Based on a schematic diagram of a connection relationship illustrated in FIG. 1, a computing power scheduling method may be provided. As illustrated in FIG. 2, FIG. 2 is a schematic flow chart of the computing power scheduling method according to an embodiment of the present disclosure. As illustrated in FIG. 2, the method may include the following operations at blocks of FIG. 2.

The operation at block 201: in a case where a first core obtains a first to-be-processed task, the first core may determine whether a computing power required by the first to-be-processed task exceeds a computing power range of the first core. The first core may be any one of the N cores.

In the embodiment of the present disclosure, the first to-be-processed task may be triggered on the wearable device. For example, a user may initiate a data transmission task on the wearable device. In some embodiments, a system running on the wearable device may actively initiate the data transmission task. The data transmission task may be configured to transmit data to the electronic device.

The first to-be-processed task may also be triggered on the electronic device. For example, the electronic device may initiate a message display task to the wearable device. In some embodiments, the user may initiate the message display task on the electronic device. The message display task may be configured to display a message received by the electronic device on the wearable device.

The computing power of a core may generally refer to a processing capability of the core. For example, if the core is a central processing unit (CPU), the computing power of the core may refer to the computing power of the CPU. The computing power of the CPU may be related to a main frequency of the CPU and a floating-point calculation value per cycle. For example, a theoretical computing power of the CPU=the main frequency of the CPU×the number of floating-point calculations performed by the CPU per clock cycle.

In the embodiment of the present disclosure, the computing power required by the first to-be-processed task may be capability required to process the first to-be-processed task. The computing power range of the first core may be capability supported by the computing power of the first core.

In the embodiment of the present disclosure, it may be determined, based on whether the capability required to process the first to-be-processed task exceeds the capability supported by the computing power of the first core, whether the computing power required by the first to-be-processed task exceeds the computing power range of the first core. For example, the computing power required by the first to-be-processed task may include: a capability 1 and a capability 4; and the computing power range of the first core may include the capability 1, a capability 2, and a capability 3. In this case, the computing power required by the first to-be-processed task may exceed the computing power range of the first core. For another example, the computing power required by the first to-be-processed task may include the capability 1 and the capability 2; and, the computing power range of the first core may include the capability 1, the capability 2, and the capability 3. In this case, the computing power required by the first to-be-processed task may not exceed the computing power range of the first core.

In the embodiment of the present disclosure, the computing power required by the first to-be-processed task may be represented by the capability required to process the first to-be-processed task; the computing power range of the first core may be represented by the capability supported by the computing power of the first core. Compared with direct representation by computing power values, the representation by capabilities may make it more intuitive to determine whether the capability required to process the first to-be-processed task exceeds the capability supported by the computing power of the first core.

The first core may be a core running on an operating system currently running on the wearable device.

The operation at block 202: in a case where the computing power required by the first to-be-processed task exceeds the computing power range of the first core, the first core may determine the target computing power provider based on the computing power required by the first to-be-processed task, the computing power ranges of the N cores, and the computing power range of the electronic device. The computing power required by the first to-be-processed task may fall within the computing power range of the target computing power provider. The target computing power provider may be at least one of the N cores and the electronic device.

In the embodiment of the present disclosure, if the computing power required by the first to-be-processed task exceeds the computing power range of the first core, the first to-be-processed task may not be processed by the first core alone. In this case, the capabilities of other cores and/or the electronic device may be adopted to process the first to-be-processed task.

For example, taking N=2 as an example, the N cores may include the core 1 and the core 2. The computing power range of the core 1 may include the capability 1, the capability 2, and the capability 3. The computing power range of the core 2 may include the capability 4, a capability 5, and a capability 6. The computing power range of the electronic device may include a capability 7 and a capability 8. If the computing power required by the first to-be-processed task includes the capability 1 and the capability 2, the computing power required by the first to-be-processed task may not exceed the computing power range of the core 1, and the first to-be-processed task may be directly processed by the core 1. If the computing power required by the first to-be-processed task includes the capability 1 and the capability 4, the computing power required by the first to-be-processed task may exceed the computing power range of the core 1, and the target computing power provider may be determined as the core 1 and the core 2. At this time, the computing power range of the target computing power provider (the core 1 and the core 2) may include the capability 1, the capability 2, the capability 3, the capability 4, the capability 5, and the capability 6, and the computing power required by the first to-be-processed task may fall within the computing power range of the target computing power provider.

If the computing power required by the first to-be-processed task includes the capability 1 and the capability 7, the computing power required by the first to-be-processed task may exceed the computing power range of the core 1, and the target computing power provider may be determined as the core 1 and the electronic device. At this time, the computing power range of the target computing power provider (the core 1 and the electronic device) may include the capability 1, the capability 2, the capability 3, the capability 7, and the capability 8. The computing power required by the first to-be-processed task may fall within the computing power range of the target computing power provider.

If the computing power required by the first to-be-processed task includes the capability 4 and the capability 7, the computing power required by the first to-be-processed task may exceed the computing power range of the core 1, and the target computing power provider may be determined as the core 2 and the electronic device. At this time, the computing power range of the target computing power provider (the core 2 and the electronic device) may include the capability 4, the capability 5, the capability 6, the capability 7, and the capability 8. The computing power required by the first to-be-processed task may fall within the computing power range of the target computing power provider.

If the computing power required by the first to-be-processed task includes the capability 1, the capability 4, and the capability 7, the computing power required by the first to-be-processed task may exceed the computing power range of the core 1, and the target computing power provider may be determined as the core 1, the core 2, and the electronic device. At this time, the computing power range of the target computing power provider (the core 1, the core 2, and the electronic device) may include the capability 1, the capability 2, the capability 3, the capability 4, the capability 5, the capability 6, the capability 7, and the capability 8. The computing power required by the first to-be-processed task may fall within the computing power range of the target computing power provider.

The computing power ranges of any two cores among the N cores may be different. The computing power ranges of the N cores and the computing power range of the electronic device may be different from each other. For example, taking N=2 as an example, the N cores may include the core 1 and the core 2. The computing power range of the core 1 may include the capability 1, the capability 2, and the capability 3; the computing power range of the core 2 may include the capability 3, the capability 4, and the capability 5; and, the computing power range of the electronic device may include the capability 5 and the capability 6.

In some embodiments, the computing power ranges of the N cores may not overlap with each other, and the computing power range of the electronic device may not overlap with the computing power ranges of the N cores. For example, taking N=2 as an example, the N cores may include the core 1 and the core 2. The computing power range of the core 1 may include the capability 1, the capability 2, and the capability 3; the computing power range of the core 2 may include the capability 4, the capability 5, and the capability 6; and, the computing power range of the electronic device may include the capability 7 and the capability 8.

In the embodiment of the present disclosure, since the computing power ranges of the N cores and the electronic device do not overlap with each other, during computing power scheduling, tasks with low computing power requirements may be allocated to the computing power providers with low computing capabilities, and tasks with high computing power requirements may be allocated to computing power providers with high computing capabilities. This may prevent a case, where the computing power providers with high computing capabilities from being frequently awakened due to tasks with low computing power requirements being allocated to these computing power providers. In this case, power consumption of the entire computing power scheduling may be reduced.

The computing power ranges of the N cores and the computing power range of the electronic device may be stored in a memory (non-volatile memory) of the first core. For example, the computing power ranges of the N cores and the computing power range of the electronic device may be stored in the memory of the first core in a form of a routing table.

In some embodiments, in the operation at block 202, the operation where the first core determining the target computing power provider based on the computing power required by the first to-be-processed task, the computing power ranges of the N cores, and the computing power range of the electronic device may include the following operations.

Operation (11): the first core may determine the computing power range within which the computing power required by the first to-be-processed task falls.

Operation (12): the first core may determine the target computing power provider based on the computing power range within which the computing power required by the first to-be-processed task falls, the computing power ranges of the N cores, and the computing power range of the electronic device. The computing power range of the target computing power provider may include the computing power range within which the computing power required by the first to-be-processed task falls.

In the embodiment of the present disclosure, taking N=2 as an example, the N cores may include the core 1 and the core 2. The computing power range of the core 1 may include the capability 1, the capability 2, and the capability 3; the computing power range of the core 2 may include the capability 4, the capability 5, and the capability 6; and, the computing power range of the electronic device may include the capability 7 and the capability 8. If the computing power required by the first to-be-processed task includes the capability 1 and the capability 4, the computing power range within which the computing power required by the first to-be-processed task falls may include the computing power range of the core 1 and the computing power range of the core 2, and the target computing power provider may include the core 1 and the core 2. If the computing power required by the first to-be-processed task includes the capability 1 and the capability 7, the computing power range within which the computing power required by the first to-be-processed task falls may include the computing power range of the core 1 and the computing power range of the electronic device, and the target computing power provider may include the core 1 and the electronic device. If the computing power required by the first to-be-processed task includes the capability 4 and the capability 7, the computing power range within which the computing power required by the first to-be-processed task falls may include the computing power range of the core 2 and the computing power range of the electronic device, and the target computing power provider may include the core 2 and the electronic device. If the computing power required by the first to-be-processed task includes the capability 1, the capability 4, and the capability 7, the computing power range within which the computing power required by the first to-be-processed task falls may include the computing power range of the core 1, the computing power range of the core 2, and the computing power range of the electronic device, and the target computing power provider may include the core 1, the core 2, and the electronic device.

The operation at block 203: the first core may process the first to-be-processed task by using the target computing power provider.

In the embodiment of the present disclosure, if the number of the target computing power providers is 1, the target computing power provider may not be the first core. If the number of the target computing power providers is at least 2, the target computing power provider may or may not include the first core.

Taking N=2 as an example, the N cores may include the core 1 and the core 2. If the target computing power provider is the core 2, the core 1 may send the first to-be-processed task to the core 2 through a hardware bus for processing. If the target computing power provider is the electronic device, the core 1 may send the first to-be-processed task to the electronic device through a wireless connection (such as a Bluetooth connection) for processing.

If the target computing power provider includes the core 2 and the electronic device, the first to-be-processed task may be split into two subtasks, one of the two sub-tasks may be sent to the core 2 for processing, and another of the two subtasks may be sent to the electronic device for processing. The computing power required by the subtask processed by the core 2 may fall within the computing power range of the core 2, and the computing power required by the subtask processed by the electronic device may fall within the computing power range of the electronic device.

If the target computing power provider includes the core 1, the core 2, and the electronic device, the first to-be-processed task may be split into three subtasks, one of the three subtasks may be sent to the core 1 for processing, another of the three subtasks may be sent to the core 2 for processing, and yet another of the three subtasks may be sent to the electronic device for processing for processing. The computing power required by the subtask processed by the core 1 may fall within the computing power range of the core 1, the computing power required by the subtask processed by the core 2 may fall within the computing power range of the core 2, and the computing power required by the subtask processed by the electronic device may fall within the computing power range of the electronic device.

In the embodiment of the present disclosure, after the first core obtains the first to-be-processed task, if the computing power required by the first to-be-processed task exceeds the computing power range of the first core, the target computing power provider may be determined, such that the computing power required by the first to-be-processed task may fall within the computing power range of the target computing power provider, and thus the target computing power provider may be used to process the first to-be-processed task. Since the target computing power provider is at least one of the N cores and the electronic device, the computing power of the N cores and the electronic device may be fully utilized to process the first to-be-processed task, thereby enhancing the computing capability of the wearable device.

In some embodiments, in the operation at block 203, the operation where the first core processing the first to-be-processed task by using the target computing power provider may include the following operations.

Operation (21): in a case where the number of the target computing power providers is 1, and the target computing power provider is one of the N cores or the electronic device, the first core may send a data processing command and to-be-processed data to the target computing power provider. The data processing command may carry a computing power provider identifier of the target computing power provider and a computing power identifier of the computing power required by the first to-be-processed task. The computing power provider identifier may be configured for verification by the target computing power provider, and may also be figured for the target computing power provider to call, according to the computing power identifier, matched computing power to process the to-be-processed data in response to the verification of the computing power provider identifier being successful.

In the embodiment of the present disclosure, when the number of target computing power providers is 1, the target computing power provider may not be the first core. The target computing power provider may be one of the N cores except the first core. In some embodiments, the target computing power provider may be the electronic device.

If the target computing power provider is one of the N cores except the first core, the first core may send the data processing command and the to-be-processed data to the target computing power provider through the hardware bus. The data processing command may carry the computing power provider identifier of the target computing power provider and the computing power identifier of the computing power required by the first to-be-processed task. The target computing power provider may verify the computing power provider identifier. In a case where the verification of the computing power provider identifier is successful, the target computing power provider may call the matched computing power to process the to-be-processed data according to the computing power identifier.

The to-be-processed data may be original data required for performing the first to-be-processed task. The hardware bus may be a serial peripheral interface (SPI) bus, an inter-integrated circuit (I2C) bus, or the like. Compared with a software bus, the hardware bus may have better connection reliability.

If the target computing power provider is the electronic device, the first core may send the data processing command and the to-be-processed data to the target computing power provider through a wireless connection. The wireless connection may such as a Bluetooth connection. The data processing command may carry the computing power provider identifier of the target computing power provider and the computing power identifier of the computing power required by the first to-be-processed task. The target computing power provider may be configured to verify the computing power provider identifier, and may also be configured to call, according to the computing power identifier, the matched computing power to process the to-be-processed data when the verification of the computing power provider identifier is successful.

In some embodiments, the data processing command and the to-be-processed data may be placed in one data packet. A header of the data packet may carry the computing power provider identifier of the target computing power provider and the computing power identifier of the computing power required by the first to-be-processed task. The format of the data packet is illustrated in Table 1.

TABLE 1

| | | |
|---|---|---|
| CP1 | Token5 | to-be-processed data |

CP1 may be the computing power provider identifier of the target computing power provider. Token5 is the computing power identifier of the computing power required by the first to-be-processed task.

For example, in a case where the computing power provider identifier of the target computing power provider is CP1, and the computing power matching with the computing power identifier Token5 is the capability 5, after receiving the data packet, the target computing power provider may verify whether its own computing power provider identifier CP1 is the same as the CP1 in the header of the data packet. In a case where the computing power provider identifier CP1 of the target computing power provider is the same as the CP1 in the header of the data packet, the target computing power provider may call the capability 5 matching with the computing power identifier Token5 to process the to-be-processed data.

In some embodiments, the data processing command and the to-be-processed data may be placed in two separate data packets, namely a data packet 1 and a data packet 2, respectively. The data packet 1 may carry the computing power provider identifier of the target computing power provider and the computing power identifier of the computing power required by the first to-be-processed task. The data packet 2 may carry the to-be-processed data.

In some embodiments, in the operation at block 203, the operation where the first core processing the first to-be-processed task by using the target computing power provider may include the following operations.

Operation (31): in a case where the target computing power providers include M computing power providers, and the M computing power providers include the first core and M−1 computing power providers, the first core may split the first to-be-processed task into a first subtask and M−1 subtasks. The computing power required by the first subtask may fall within the computing power range of the first core, and the computing power required by the M−1 subtasks may respectively fall within the computing power ranges of the M−1 computing power providers. M is an integer greater than or equal to 2.

Operation (32): the first core may process the first subtask, and a first computing power provider may process a second subtask. The first computing power provider may be any one of the M−1 computing power providers. The computing power required by the second subtask may fall within the computing power range of the first computing power provider.

In a case where the number of target computing power providers is greater than or equal to 2, the target computing power providers may or may not include the first core. The operations (31) to (32) above are for the case where the target computing power providers include the first core. The operations (41) to (42) below are for the case where the target computing power providers do not include the first core.

In the embodiment of the present disclosure, the target computing power providers are at least one of the N cores and the electronic device. In a case where the target computing power providers include the first core and M−1 cores, the M−1 cores may or may not include the electronic device. The cores and the electronic device may be abstracted as computing power providers.

In a case where the target computing power providers include the first core, if the number of target computing power providers is M, the first to-be-processed task may be split into M subtasks according to the number of target computing power providers. The M subtasks may include the first subtask and the M−1 subtasks. The first subtask may be directly processed by the first core, and the M−1 subtasks may need to be processed by the M−1 computing power providers respectively. Specifically, the first core may process the first subtask, and the first core may send a data processing command matching with the second subtask and the to-be-processed data matching with the second subtask to the first computing power provider. The data processing command matching with the second subtask may carry the computing power provider identifier of the first computing power provider and the computing power identifier of the computing power required by the second subtask. After receiving the data processing command matching with the second subtask and the to-be-processed data matching with the second subtask, a computing power provider identifier of the first computing power provider may be verified. In a case where the verification is successful, corresponding computing power may be called to process the to-be-processed data matching with the second subtask according to the computing power identifier of the computing power required by the second subtask. For details, reference may be made to the relevant description of the operation (21) above, and no further description would be provided here.

After the first core assigns the M−1 subtasks to the M−1 computing power providers for processing, the M−1 computing power providers may send the processing results of the M−1 subtasks back to the first core. The first core may perform merging processing on the processing result of the first subtask and the processing results of the M−1 subtasks, thereby obtaining the processing result of the first to-be-processed task.

In the embodiment of the present disclosure, in a case where the target computing power providers include M computing power providers, and the M computing power providers include the first core and the M−1 computing power providers, the first core may split the first to-be-processed task into the first subtask and the M−1 subtasks. The first core may process the first subtask directly, and the M−1 subtasks may be assigned to the M−1 computing power providers for processing. By splitting the first to-be-processed task into M subtasks, one assigned to the first core itself for processing, and the rest assigned to the M−1 computing power providers for processing, parallel processing of the subtasks may be realized, and the task processing efficiency may be increased.

In some embodiments, in the operation at block 203, the operation where the first core processing the first to-be-processed task by using the target computing power provider may include the following operations.

Operation (41): in a case where the target computing power providers include the M computing power providers, and the M computing power providers do not include the first core, the first core may split the first to-be-processed task into M subtasks. The computing power required by the M subtasks may respectively fall within the computing power ranges of the M computing power providers. M is an integer greater than or equal to 2;

Operation (42): the first core may process a third subtask through a second computing power provider. The second computing power provider may be any one of the M cores, and the computing power required by the third subtask may fall within the computing power range of the second computing power provider.

In the embodiment of the present disclosure, the target computing power providers may be at least one of the N cores and the electronic device. In a case where the target computing power providers include M cores, the M cores may or may not include the electronic device. The cores and the electronic device may be abstracted as computing power providers.

In a case where the target computing power providers do not include the first core, in a case where the number of target computing power providers is M, the first to-be-processed task may be split into M subtasks according to the number of target computing power providers. Since the target computing power providers do not include the first core, the first core may only play a role in splitting the task and does not process the task. The M subtasks may need to be processed by the M computing power providers respectively. Specifically, the second computing power provider may process the third subtask, and the first core may send the data processing command matching with the third subtask and the to-be-processed data matching with the third subtask to the second computing power provider. The data processing command matching with the third subtask may carry the computing power provider identifier of the second computing power provider and the computing power identifier of the computing power required by the third subtask. After receiving, by the second computing power provider, the data processing command matching with the third subtask and the to-be-processed data matching with the third subtask, the computing power provider identifier of the second computing power provider may be verified. In a case where the verification is successful, the corresponding computing power may be called to process the to-be-processed data matching with the third subtask according to the computing power identifier of the computing power required by the third subtask. For details, reference may be made to the relevant description of the operation (21) above, and no further description is provided here.

After the first core assigns the M subtasks to the M computing power providers for processing, the M computing power providers may send the processing results of the M subtasks back to the first core. The first core may perform the merging processing on the processing results of the M subtasks, thereby obtaining the processing result of the first to-be-processed task.

In the embodiment of the present disclosure, in a case where the target computing power providers include M computing power providers, and the M computing power providers do not include the first core, the first core may split the first to-be-processed task into M subtasks. Assigning the M subtasks to the M computing power providers for processing may realize parallel processing of subtasks and increase the task processing efficiency.

In some embodiments, before performing the operation (41), the following operations may also be performed.

Operation (51): the first core may determine whether all the M computing power providers meet the task performing requirements.

Operation (52): in a case where priorities of all the M computing power providers meet the task performing requirements, the operation (41) may be performed.

In the embodiment of the present disclosure, a computing power provider meeting the task performing requirements means, power level and current load of a device where the computing power provider is located meet the task performing requirements. For example, in a case where the power level of the device where the computing power provider is located is too low to perform tasks within the computing power range of the computing power provider, or in a case where the computing power provider is already performing a task and cannot continue to perform new tasks, these cases may all be considered as failing to meet the task performing requirements.

In the embodiment of the present disclosure, the computing power required by the first to-be-processed task may fall within the computing power ranges of the M computing power providers, and the M computing power providers may be those that meet the task performing requirements. The first to-be-processed task may be assigned to the computing power providers that fall within the computing power range and meet the task performing requirements, avoiding assigning the first to-be-processed task to computing power providers that do not meet the task performing requirements, thereby increasing the task processing efficiency. In some embodiments, after performing the operation (51), the following operation may also be performed.

Operation (53): in a case where there are Q computing power providers among the M computing power providers that do not meet the task performing requirements, a computing power provider that meets the task performing requirements may be selected from the N cores and the electronic device to execute the first to-be-processed task. Q is a positive integer less than or equal to M.

In the embodiment of the present disclosure, if there are Q computing power providers among the M computing power providers that do not meet the task performing requirements, it is necessary to select a computing power provider that meets the task performing requirements from the N cores and the electronic device to execute the first to-be-processed task. In the embodiment of the present disclosure, when in a case where there are computing power providers that do not meet the task performing requirements among the M computing power providers, the first to-be-processed task may be assigned to computing power providers that meet the task performing requirements, avoiding cases where the computing power providers cannot process the subtasks, thereby increasing the task processing efficiency as much as possible.

In some embodiments, after the first core processes the first to-be-processed task by using the target computing power provider, the first core may display the processing results of the target computing power providers, or display the processing result after the processing results of the target computing power providers are merged.

In some embodiments, the method illustrated in FIG. 2 may further include the following operations.

In a case where the computing power required by the first to-be-processed task does not exceed the computing power range of the first core, the first core may process the first to-be-processed task. At this time, there is no need for computing power scheduling, and the processing efficiency of the first to-be-processed task may be increased.

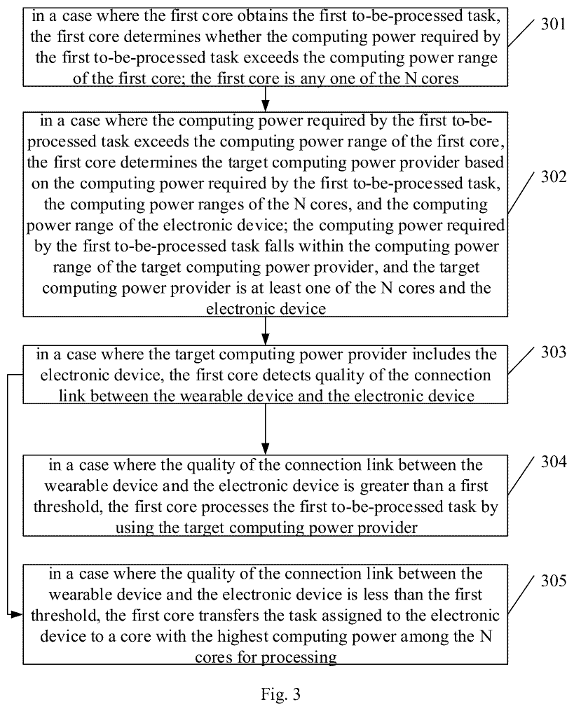

As illustrated in FIG. 3, FIG. 3 is a schematic flowchart of another computing power scheduling method according to an embodiment of the present disclosure. As illustrated in FIG. 3, the method may include the following operations.

Operation 301, in a case where the first core obtains the first to-be-processed task, the first core may determine whether the computing power required by the first to-be-processed task exceeds the computing power range of the first core. The first core may be any one of the N cores.

Operation 302: in a case where the computing power required by the first to-be-processed task exceeds the computing power range of the first core, the first core may determine the target computing power provider based on the computing power required by the first to-be-processed task, the computing power ranges of the N cores, and the computing power range of the electronic device. The computing power required by the first to-be-processed task may fall within the computing power range of the target computing power provider, and the target computing power provider may be at least one of the N cores and the electronic device.

For the specific implementation of the operations 301 to 302, reference may be made to the relevant descriptions of the operations 201 to 202 above, and no further description is provided here.

Operation 303: in a case where the target computing power provider includes the electronic device, the first core may detect quality of a connection link between the wearable device and the electronic device.

In the embodiment of the present disclosure, the quality of the connection link between the wearable device and the electronic device may be measured based on received signal strength indicator (RSSI) detected by the wearable device, and a distance between the wearable device and the electronic device.

Operation 304: in a case where the quality of the connection link between the wearable device and the electronic device is greater than a first threshold, the first core may process the first to-be-processed task by using the target computing power provider.

In the embodiment of the present disclosure, the first threshold may be configured in advance. The first threshold may be stored in the memory (such as a non-volatile memory) of the wearable device.

If the quality of the connection link between the wearable device and the electronic device is greater than the first threshold, the connection between the wearable device and the electronic device may be relatively stable, and the first core may use the electronic device to process the first to-be-processed task.

Operation 305: in a case where the quality of the connection link between the wearable device and the electronic device is less than the first threshold, the first core may transfer a task assigned to the electronic device to a core with the highest computing power among the N cores for processing.

In the embodiment of the present disclosure, in a case where the quality of the connection link between the wearable device and the electronic device is less than the first threshold, the connection between the wearable device and the electronic device may not be stable enough. In this case, transferring the task assigned to the electronic device to the core with the highest computing power among the N cores for processing may increase a possibility that the task assigned to the electronic device is processed successfully. In this way, when the connection between the wearable device and the electronic device is unstable, the task may be prevented from being assigned to the electronic device for processing, thereby avoiding cases where the electronic device cannot send the task processing result back to the first core, the task processing efficiency may be increased.

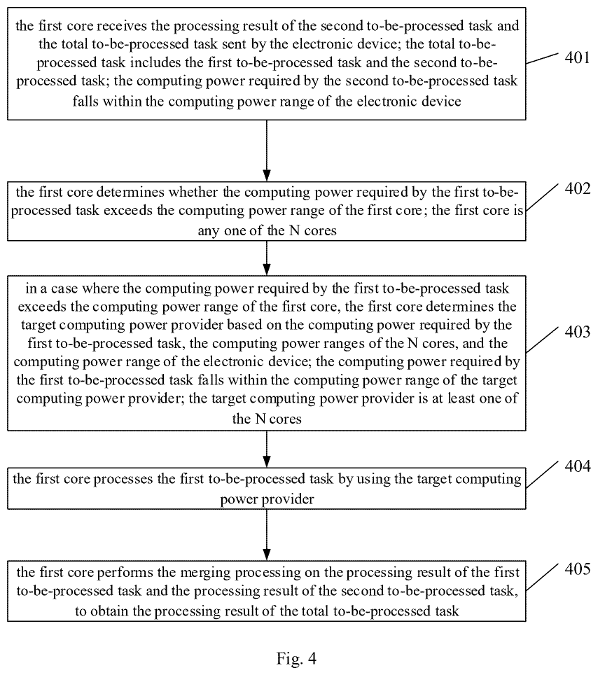

As illustrated in FIG. 4, FIG. 4 is a schematic flowchart of another computing power scheduling method according to an embodiment of the present disclosure. As illustrated in FIG. 4, the method may include the following operations.

Operation 401: the first core may receive a processing result of a second to-be-processed task and a total to-be-processed task sent by the electronic device. The total to-be-processed task may include the first to-be-processed task and the second to-be-processed task. The computing power required by the second to-be-processed task may fall within the computing power range of the electronic device.

In the embodiment of the present disclosure, when the electronic device issues the total to-be-processed task to the first core, the total to-be-processed task includes the first to-be-processed task and the second to-be-processed task, in a case where the computing power required by the second to-be-processed task in the total to-be-processed task falls within the computing power range of the electronic device, the electronic device may process the second to-be-processed task in advance to obtain the processing result of the second to-be-processed task. Then, the electronic device may send the first to-be-processed task and the processing result of the second to-be-processed task to the first core. When the first core processes the first to-be-processed task, there is no need to interact with the electronic device again, which may increase the processing efficiency of the total to-be-processed task.

Operation 402: the first core may determine whether the computing power required by the first to-be-processed task exceeds the computing power range of the first core. The first core may be any one of the N cores.

Operation 403: in a case where the computing power required by the first to-be-processed task exceeds the computing power range of the first core, the first core may determine the target computing power provider based on the computing power required by the first to-be-processed task, the computing power ranges of the N cores, and the computing power range of the electronic device. The computing power required by the first to-be-processed task may fall within the computing power range of the target computing power provider. The target computing power provider may be at least one of the N cores.

Operation 404: the first core may process the first to-be-processed task by using the target computing power provider.

For the specific implementation of the operations 402 to 404, reference may be made to the operations 201 to 203 above, and no further description is provided here.

Operation 405: the first core may perform the merging processing on the processing result of the first to-be-processed task and the processing result of the second to-be-processed task, to obtain the processing result of the total to-be-processed task.

For example, if the total to-be-processed task includes the second to-be-processed task and a first to-be-processed task, the second to-be-processed task is an image processing task, the first to-be-processed task includes a text processing task and an image-text display task, the electronic device may first process the image data of the image processing task to obtain an image processing result. After sending the image processing result to the first core, the first core may schedule the N cores to process the text processing task and the image-text display task. After the first core schedules the N cores to process the text processing task, a text processing result may be obtained. Then, the image-text display task may be performed. The image processing result and the text processing result may be merged and then displayed.

In some embodiments, before performing the operation 201, the operation 301, or the operation 402, the following operation may also be performed.

Operation (61): when the wearable device is powered on, the first core may exchange its own computing power range with the N−1 cores. In a case where the computing power range of the first core changes, the first core may issue its own computing power range to the N−1 cores. The N−1 cores may be the cores among the N cores except the first core.

In the embodiment of the present disclosure, the first core may exchange its computing power range with the N−1 cores after the wearable device is powered on or restarted. Specifically, every time the wearable device is powered on or restarted, each of the N cores may issue its own computing power range to the other N−1 cores. In this way, the computing power exchange is completed among the N cores, and each core may know its own computing power range and the computing power ranges of another N−1 cores. When the wearable device is powered on, each of the N cores may also periodically issue its own computing power range to the other N−1 cores.

When the computing power range of the first core changes, the first core may also issue its computing power range to the N−1 cores. The computing power range of the first core may change. For example, the original computing power range of the first core may include the capability 1, the capability 2, and the capability 3. In a case where the first core cannot process tasks related to the capability 3 due to low power, the computing power range of the first core may change to include the capability 1 and the capability 2. In a case where the first core is already processing a task related to the capability 1 and cannot continue to process another task related to the capability 1, the computing power range of the first core may change to include the capability 2 and the capability 3.

In some embodiments, before performing the operation 201, the operation 301, or the operation 402, the following operations may also be performed.

Operation (71): in a case where a communication connection is established between the wearable device and the electronic device, the first core may issue the computing power range of the first core or the computing power ranges of the N cores to the electronic device, and obtain the computing power range of the electronic device issued by the electronic device.

In the embodiment of the present disclosure, when the communication connection is established between the wearable device and the electronic device: in a case where all N cores can communicate directly with the electronic device, each of the N cores may independently issue its own computing power range to the electronic device, and the electronic device may also issue its computing power range to each of the N cores. In a case where only one of the N cores (e.g., the first core) is able to communicate directly with the electronic device, the operation (71) may be performed after the operation (61). After the operation (61) is performed, the first core may obtain the computing power range of each of the N cores, and may issue the computing power range of each of the N cores to the electronic device, such that the electronic device may obtain the computing power range of each of the N cores. The electronic device may also issue its computing power range to the first core. The electronic device only needs to perform computing power exchange with one of the N cores to obtain the computing power range of each of the N cores, which may increase the efficiency of computing power exchange between the electronic device and the N cores. In a case where only one of the N cores (e.g., the first core) is able to communicate directly with the electronic device, after performing the operation (71), the first core may issue the computing power range of the electronic device to the N−1 cores. The first core may issue its own computing power range or the computing power range of each of the N cores to the electronic device every time the communication connection is established between the wearable device and the electronic device. When the communication connection is established between the wearable device and the electronic device, the first core may also periodically issue its own computing power range or the computing power range of each of the N cores to the electronic device.

The computing power range of the first core may be updated regularly according to load status or power level of the first core. The first core may periodically issue its own computing power range, such that the N−1 cores and the electronic device may obtain the latest computing power range of the first core in a timely manner. In this way, an accuracy of each core in obtaining the computing power ranges of other cores may be increased, thereby increasing the accuracy of computing power scheduling. In some possible embodiments, the computing power range of the first core may also be configured to a fixed value.

In a case where all N cores are able to communicate directly with the electronic device, each of the N cores may issue its own computing power range to the electronic device every time the communication connection is established between the wearable device and the electronic device. Each of the N cores may also obtain the computing power range of the electronic device issued by the electronic device, such that computing power exchange may be realized between the electronic device and each of the N cores. For example, when the communication connection is established between the wearable device and the electronic device, each of the N cores may periodically issue its own computing power range to the electronic device, and the electronic device may also periodically issue its computing power range to the N cores.

The computing power range of the electronic device may be updated regularly according to the load status or the power level of the electronic device. The electronic device may periodically issue its own computing power range, such that the N cores may obtain the latest computing power range of the electronic device in a timely manner. In this way, the accuracy of each core in obtaining the computing power range of the electronic device may be increased, thereby increasing the accuracy of the computing power scheduling. In some possible embodiments, the computing power range of the electronic device may also be configured to a fixed value.

In the following, an example may be used to illustrate the computing power scheduling process, where N=2, P=2, the electronic device is a mobile phone, and the wearable device is a smart watch. The N cores may include a small core and a large core.

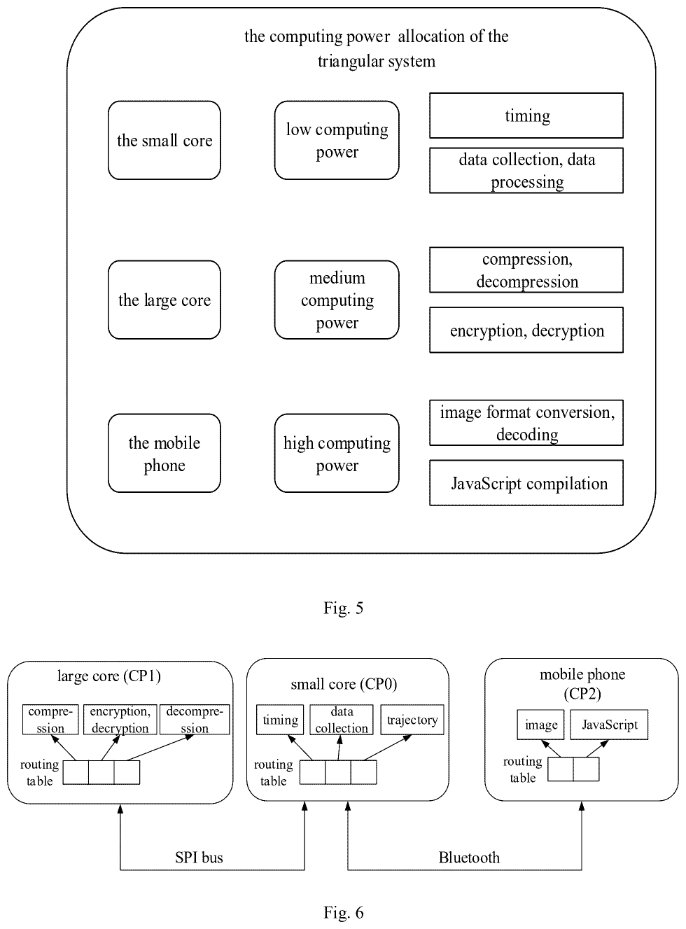

The small core, the large core, and the mobile phone may form a triangular system. The small core and the large core may be connected through an SPI bus. A smart watch and the mobile phone may be connected through the Bluetooth. The allocation of computing power in the triangular system is illustrated in FIG. 5. FIG. 5 is a schematic diagram of the allocation of computing power in the triangular system according to an embodiment of the present disclosure. As illustrated in FIG. 5: the small core may have a low computing power, and tasks such as timing, data collection and processing, and route recording may be assigned to the small core for performing. The large core may have medium computing power, and tasks such as compression and decompression, and data encryption and decryption may be assigned to the large core for performing. The mobile phone may have a high computing power, and tasks such as image format conversion and image decoding, JavaScript compilation, and bytecode generation may be assigned to the mobile phone for performing. The computing power range of the small core may include timing, data collection, processing, or the like. The computing power range of the large core may include compression, decompression, encryption, decryption, or the like. The computing power range of the mobile phone may include image format conversion, image decoding, JavaScript compilation, bytecode generation, or the like.

As illustrated in FIG. 6, FIG. 6 is a schematic diagram of computing power issuance in the triangular system according to an embodiment of the present disclosure. As illustrated in FIG. 6, in the triangular system, each core providing computing power may correspond to one computing power provider (CP). It may be agreed that: the small core corresponds to CP0, the large core corresponds to CP1, and the mobile phone corresponds to CP2. Each CP may have a built-in routing table. Different capabilities may correspond to one entry in the routing table, and a token may be used for marking. When the watch is powered on, the large core and the small core may inform each other of their own computing power. When the communication connection is established between the mobile phone and the watch, the mobile phone and the small core may inform each other of their own computing power, and the mobile phone and the large core may inform each other of their own computing power. In this way, each CP may have a complete set of computing power, part of the set is the own computing power of the each CP, and the remaining computing power comes from the other two CPs.

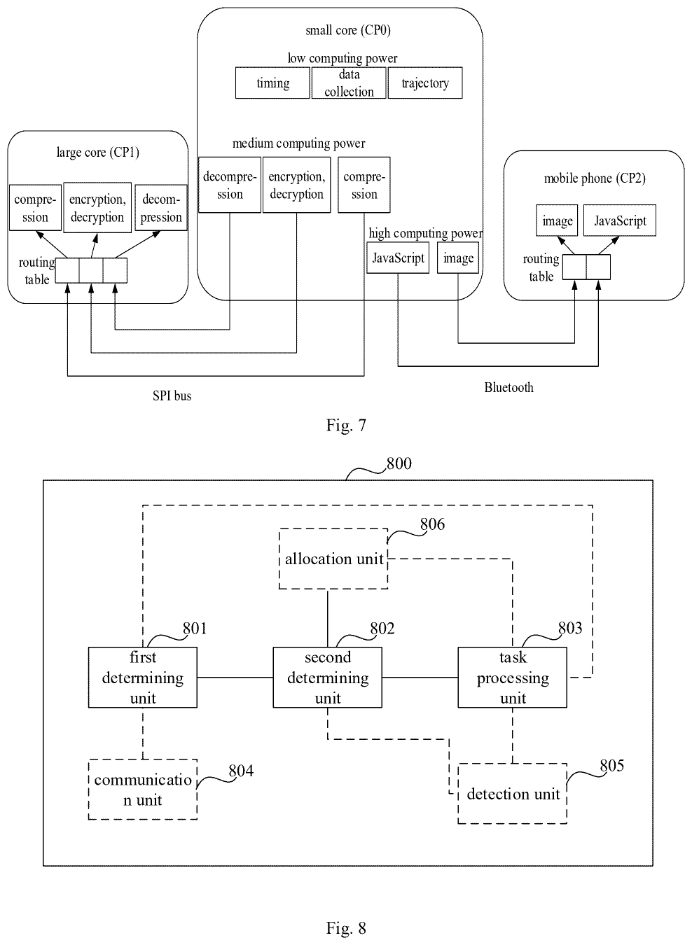

As illustrated in FIG. 7, FIG. 7 is a schematic diagram of computing power scheduling in the triangular system according to an embodiment of the present disclosure. FIG. 7 takes the small core as an example to illustrate the computing power scheduling.

If the to-be-processed task is a low-computing-power task, the small core may complete the to-be-processed task by itself.

If the to-be-processed task is a medium-computing-power task, since the large core has already issued its own computing power (matching with the medium computing power) to the small core, the small core may use the computing power of the large core. The specific method may be: the small core may send a command (CMD) and service data to the large core through the SPI bus; data header may carry {CP1+Token} to indicate which specific computing power is to be used; then the service data may be transmitted. For example, if the computing power for decompression is applied for, the compressed data may be sent. Another types of computing power may follow a similar process.

If the to-be-processed task is a high-computing-power task, since the mobile phone has already issued its own computing power (matching with the high computing power) to the small core when the Bluetooth connection is successfully established, the small core may use the computing power of the mobile phone. The specific method may be: the command (CMD) and the service data may be sent to the mobile phone through Bluetooth; the data header may carry {CP2+Token} to indicate which specific computing power is to be used; then the service data may be transmitted. For example, if the computing power for image processing is applied for, the image data may be sent. Another types of computing power may follow a similar process.

Since the Bluetooth connection between the mobile phone and the watch may be unstable, relevant considerations for the Bluetooth connection may be taken before using the high computing power. If the Bluetooth connection is not stable enough, a second-best option may be adopted: using the computing power of the large core to perform similar tasks.

The command and the service data may be placed in one data packet, as illustrated in Table 2.

TABLE 2

| | | |
|---|---|---|
| CP | Token | Service Data |

A CP field may be bound to a specific core or the mobile phone, and thus may be bound to a specific connection, which is either the SPI bus or the Bluetooth. The Token may mark specific a computing power. The Token is a marker. If the computing power routing table is designed as an array, the Token may be an index of the matched computing power in the routing array.

In the embodiment of the present disclosure, on one hand, the small core may assign time-consuming operations, that affect user experience, to the large core or the mobile phone. The small core may directly obtain a final result and display the same to the user, eliminating intermediate time-consuming operations and enhancing performance of the triangular system. For example, tasks such as data decompression and decryption, image decoding, and JavaScript script compilation may be extremely CPU-intensive, and may overload the small core. These tasks may be assigned to the large core or the mobile phone. After the tasks have been finished, the large core or the mobile phone may return the results to the small core through the SPI bus or the Bluetooth.

On the other hand, the large core may assign low-computation tasks that require frequent wake-ups, such as periodic wake-ups, data collection, and trajectory recording, to the small core, and then enter a sleep state. In this way, the power consumption may be saved, and the battery life may be enhanced.

For the triangular system consisting of the large core, the small core, and the mobile phone, the timing of computing power scheduling may also be advanced to an origin or source of the operation or data, and scheduling may be performed at the data source. For example, for the image data: if the image comes from the mobile phone, the mobile phone may use its own computing power to decode the image in advance, and then send the decoded data to the watch. If the computing power scheduling is initiated by the small core, a calculation result may be returned to the small core. If the computing power scheduling is initiated by the large core, the calculation result may be returned to the large core. In this way, the efficiency of computing power scheduling may be enhanced.

The above mainly introduces the scheme of the embodiments of the present disclosure from the perspective of the performing process on the method side. It may be understood that, in order to implement the above functions, the wearable device may include corresponding hardware structures and/or software modules for performing each function. Those skilled in the art should easily realize that, in combination with the units of the examples and the algorithm operations described in the embodiments provided in the present document, the present disclosure may be implemented in the form of hardware or a combination of hardware and computer software. Whether a certain function is performed by hardware or by computer software driving hardware depends on the specific application and design constraints of the technical solution. Professional technicians may use different methods to implement the described functions for each specific application, but such implementation should not be considered beyond the scope of the present disclosure.

In the embodiment of the present disclosure, functional units of the wearable device may be divided according to the above-mentioned method examples. For example, each function may be divided into corresponding functional units, or two or more functions may be integrated into one processing unit. The above-integrated units may be implemented in the form of hardware, or may be implemented in the form of software functional units. It should be noted that the division of units in the embodiment of the present disclosure is schematic and is only a logical function division; there may be other division methods in actual implementation.

As illustrated in FIG. 8, FIG. 8 is a schematic structural diagram of a computing power scheduling apparatus according to an embodiment of the present disclosure. The computing power scheduling apparatus 800 may be applied to the wearable device. The wearable device may include N cores. N is an integer greater than or equal to 2. The wearable device may establish the communication connection with the electronic device. The computing power scheduling apparatus 800 may include a first determining unit 801, a second determining unit 802, and a task processing unit 803.

The first determining unit 801 may be configured to: in a case where the first core obtains the first to-be-processed task, determine whether the computing power required by the first to-be-processed task exceeds the computing power range of the first core. The first core may be any one of the N cores.

The second determining unit 802 may be configured to: in a case where the computing power required by the first to-be-processed task exceeds the computing power range of the first core, determine the target computing power provider based on the computing power required by the first to-be-processed task, the computing power ranges of the N cores, and the computing power range of the electronic device. The computing power required by the first to-be-processed task may fall within the computing power range of the target computing power provider. The target computing power provider may be at least one of the N cores and the electronic device.

The task processing unit 803 may be configured to process, through the target computing power provider, the first to-be-processed task.

In some embodiments, the computing power scheduling apparatus 800 may further include a communication unit 804.

The communication unit 804 may be configured to: issue the computing power range of the first core to the N−1 cores and the electronic device. The N−1 cores are the cores among the N cores except the first core.

The communication unit 804 may be further configured to: obtain the computing power range of the electronic device issued by the electronic device.

In some embodiments, the communication unit 804 may be configured to: in a case where the wearable device is powered on, exchange its own computing power range with the N−1 cores. In a case where the computing power range of the first core changes, the first core may issue the computing power range of the first core to the N−1 cores. The N−1 cores may be the cores among the N cores except the first core.

In some embodiments, the communication unit 804 may be configured to: in a case where the communication connection is established between the wearable device and the electronic device, issue the computing power range of the first core or the computing power ranges of the N cores to the electronic device, and obtain the computing power range of the electronic device issued by the electronic device.

In some embodiments, the operation where the second determining unit 802 determines the target computing power provider based on the computing power required by the first to-be-processed task, the computing power ranges of the N cores, and the computing power range of the electronic device may include: determining the computing power range within which the computing power required by the first to-be-processed task falls; determining the target computing power provider based on the computing power range within which the computing power required by the first to-be-processed task falls, the computing power ranges of the N cores, and the computing power range of the electronic device. The computing power range of the target computing power provider may include the computing power range within which the computing power required by the first to-be-processed task falls.

In some embodiments, the operation where the task processing unit 803 processes the first to-be-processed task through the target computing power provider may include: in a case where the number of the target computing power providers is 1, and the target computing power provider is one of the N cores or the electronic device, sending the data processing command and the to-be-processed data to the target computing power provider. The data processing command may carry the computing power provider identifier of the target computing power provider and the computing power identifier of the computing power required by the first to-be-processed task. The computing power provider identifier may be configured for verification by the target computing power provider, and when the verification of the computing power provider identifier is successful, the computing power provider identifier may also be configured for the target computing power provider to call the matched computing power to process the to-be-processed data according to the computing power identifier.

In some embodiments, the operation where the task processing unit 803 processes the first to-be-processed task through the target computing power provider may include: in a case where the target computing power providers include M computing power providers, and the M computing power providers include the first core and the M−1 computing power providers, splitting the first to-be-processed task into the first subtask and the M−1 subtasks. The computing power required by the first subtask may fall within the computing power range of the first core, and the computing power required by the M−1 subtasks may respectively fall within the computing power ranges of the M−1 computing power providers, where M is an integer greater than or equal to 2; processing the first subtask, and processing the second subtask through the first computing power provider. The first computing power provider may be any one of the M−1 computing power providers. The computing power required by the second subtask may fall within the computing power range of the first computing power provider.

In some embodiments, the operation where the task processing unit 803 processes the first to-be-processed task through the target computing power provider may include: in a case where the target computing power providers include M computing power providers, and the M computing power providers do not include the first core, splitting the first to-be-processed task into the M subtasks. The computing power required by the M subtasks may respectively fall within the computing power ranges of the M computing power providers, where M is an integer greater than or equal to 2; processing the third subtask through the second computing power provider. The second computing power provider may be any one of the M cores. The computing power required by the third subtask may fall within the computing power range of the second computing power provider.

In some embodiments, the first determining unit 801 may be further configured to: determine whether all the M computing power providers meet the task performing requirements.

The task processing unit 803 may be further configured to: in a case where the priorities of all the M computing power providers meet the task performing requirements, split the first to-be-processed task into M subtasks.

In some embodiments, the task processing unit 803 may be further configured to: in a case where there are Q computing power providers among the M computing power providers that do not meet the task performing requirements, select the computing power provider that meets the task performing requirements from the N cores and the electronic device to perform the first to-be-processed task.

In some embodiments, the computing power scheduling apparatus 800 may further include a detection unit 805.

The detection unit 805 may be configured to: in a case where the target computing power provider includes the electronic device, detect the quality of the connection link between the wearable device and the electronic device.

The task processing unit 803 may be further configured to: in a case where the quality of the connection link between the wearable device and the electronic device is greater than the first threshold, process the first to-be-processed task through the target computing power provider.

In some embodiments, the computing power scheduling apparatus 800 may further include an allocation unit 806.

The allocation unit 806 may be configured to: in a case where the quality of the connection link between the wearable device and the electronic device is less than the first threshold, transfer the task assigned to the electronic device to the core with the highest computing power among the N cores for processing.

In some embodiments, the communication unit 804 may be further configured to: receive the processing result of the second to-be-processed task and the total to-be-processed task sent by the electronic device. The total to-be-processed task may include the first to-be-processed task and the second to-be-processed task. The computing power required by the second to-be-processed task may fall within the computing power range of the electronic device;

The task processing unit 803 may be further configured to: perform the merging processing on the processing result of the first to-be-processed task and the processing result of the second to-be-processed task, to obtain the processing result of the total to-be-processed task.

In some embodiments, the computing power ranges of the N cores may not overlap with each other. The computing power range of the electronic device may not overlap with the computing power ranges of the N cores.

In some embodiments, the N cores may run on P operating systems respectively. P is an integer less than or equal to N and greater than or equal to 2.

The first determining unit 801, the second determining unit 802, the task processing unit 803, the detection unit 805, and the allocation unit 806 in the embodiment of the present disclosure may be processors in the wearable device. The communication unit 804 may be a communication module in the wearable device.

In the embodiment of the present disclosure, after the first core obtains the first to-be-processed task, if the computing power required by the first to-be-processed task exceeds the computing power range of the first core, the target computing power provider may be determined, such that the computing power required by the first to-be-processed task may fall within the computing power range of the target computing power provider, and thus the target computing power provider may be configured to process the first to-be-processed task. Since the target computing power provider is at least one of the N cores and the electronic device, the computing power of the N cores and the electronic device may be fully utilized to process the first to-be-processed task, thereby enhancing the computing capability of the wearable device.

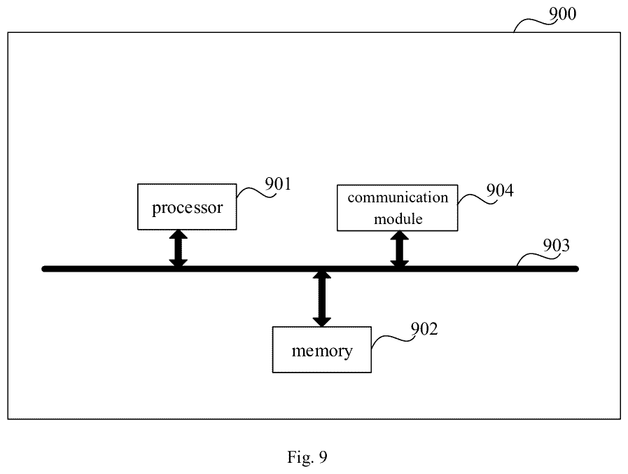

As illustrated in FIG. 9, FIG. 9 is a schematic structural diagram of the wearable device according to an embodiment of the present disclosure. As illustrated in FIG. 9, the wearable device 900 may include a processor 901 and a memory 902. The processor 901 and the memory 902 may be connected to each other through a communication bus 903. The processor 901 may include N cores. N is an integer greater than or equal to 2. The communication bus 903 may be a Peripheral Component Interconnect (PCI) bus, an Extended Industry Standard Architecture (EISA) bus, or the like. The communication bus 903 may be divided into an address bus, a data bus, a control bus, or the like. For the convenience of representation, only one thick line is illustrated in FIG. 9, but this does not mean that there is only one bus or one type of bus. The memory 902 is configured to store a computer program. The computer program may include program instructions. The first core in the processor 901 may be configured to call the program instructions. The above-mentioned program may include instructions for executing part or all of the operations in the methods illustrated in FIG. 2 to FIG. 7. The first core may be any one of the N cores.

The first core may be a general-purpose central processing unit (CPU), a microprocessor, an application-specific integrated circuit (ASIC), or one or more integrated circuits for controlling the performing of the programs in the above-mentioned schemes.

The memory 902 may be a read-only memory (ROM) or another type of static storage device capable of storing static information and instructions, a random access memory (RAM) or another type of dynamic storage device capable of storing information and instructions, an electrically erasable programmable read-only memory (EEPROM), a compact disc read-only memory (CD-ROM) or another optical disc storage device (including compact discs, laser discs, optical discs, digital versatile discs, Blu-ray discs, or the like), a magnetic disk storage medium or another magnetic storage device, or any other medium that may be configured to carry or store desired program code in the form of instructions or data structures and may be accessed by a computer, but is not limited thereto. The memory may exist independently and be connected to the processor through a bus. The memory may also be integrated with the processor.

The wearable device 900 may further include a communication module 904. The communication module 904 may include general components such as a communication interface, an antenna, etc.

In the embodiment of the present disclosure, after the first core obtains the first to-be-processed task, in a case where the computing power required by the first to-be-processed task exceeds the computing power range of the first core, the target computing power provider may be determined, such that the computing power required by the first to-be-processed task may fall within the computing power range of the target computing power provider, and thus the target computing power provider may be configured to process the first to-be-processed task. Since the target computing power provider is at least one of the N cores and the electronic device, the computing power of the N cores and the electronic device may be fully utilized to process the first to-be-processed task, thereby enhancing the computing capability of the wearable device.

The embodiment of the present disclosure may further provide a computer-readable storage medium. The computer-readable storage medium may store a computer program for electronic data exchange. The computer program may enable a computer to execute part or all of the operations of any computing power scheduling method described in the above-mentioned method embodiments.

For the sake of concise description, the aforementioned method embodiments may all be expressed as a series of action combinations. However, those skilled in the art should be aware that, the present disclosure is not limited by the described order of actions, since according to the present disclosure, some operations may be performed in other orders or simultaneously. In addition, those skilled in the art should also learn that, the embodiments described in the specification are all preferred embodiments, and the actions and modules involved may not be necessarily required for the present disclosure.

In the above-mentioned embodiments, a description of each embodiment may have its own focus. A part that is not detailed in a certain embodiment may be referred to relevant descriptions of another embodiment.

In the embodiments provided in the present disclosure, it should be appreciated that, the disclosed apparatus may be embodied in other manners. For example, the apparatus embodiment described above may merely be illustrative. For example, a division of units may only be a logical function division, and there may be another division manner in actual implementations. For example, a plurality of units or components may be combined or integrated into another system, some features may be ignored or not implemented. In addition, the illustrated or discussed mutual coupling, direct coupling or communicating connection may be indirect coupling or communicating connection through some interfaces, apparatuses or units, and may be electrical or of other forms.

The units illustrated as separate components may or may not be physically separate. The components illustrated as units may or may not be physical units. The units may be located in one place or may be distributed among a plurality of network units. Some or all of the units may be selected as per actual needs to fulfill an object of an embodiment.

In addition, each functional unit in embodiments of the present disclosure may be integrated into one processing unit, or may be physically separate units, or two or more units may be integrated into one unit. The above-mentioned integrated units may be embodied in the form of hardware or software program model.

If the integrated units are implemented in the form of software functional units, and are not sold or used as an independent product, then they may be stored in a computer-readable memory. Based on such kind of understanding, the technical scheme of the present disclosure may essentially, or a part thereof contributing to the prior art, or part or all of the technical scheme may be embodied in the form of software products. The computer software products may be stored in a memory. The computer software product may include several instructions which may enable a computer device (which may be a personal computer, a server or a network device, or the like) to implement all or a part of the operations of the method according to various embodiments of the present disclosure. The afore-mentioned memory may include: a U disk, a read only memory (ROM), a random-access memory (RAM), a removable disk, a magnetic disk or a compact disk, or other medium that may store program codes.

Those of ordinary skills in the art may understand that, all or part of the operations in the methods of the above-mentioned embodiments may be completed by instructing relevant hardware through a program. The program may be stored in a computer readable memory. The memory may include: a Flash disks, a read-only memory, a random-access memory, a magnetic disk or a compact disk or the like.

The embodiments of the present disclosure are detailed above. Specific examples are applied herein to illustrate the principles and implementations of the present disclosure. The illustrations of the above-mentioned embodiments are merely for understanding the method of the present disclosure and its core ideas. Meanwhile, according to the idea of the present disclosure, specific implementation and its application scope may be changed by those of ordinary skills in the art. In summary, the contents of the specification should not be construed as a limitation on the present disclosure.

1. A computing power scheduling method, the method being applied to a wearable device, the wearable device comprising N cores, N being an integer greater than or equal to 2, the wearable device establishing a communication connection with an electronic device, wherein the method comprising:
in a case where a first core obtains a first to-be-processed task, determining whether a computing power required by the first to-be-processed task exceeds a computing power range of the first core, wherein the first core is any of the N cores;
in a case where the computing power required by the first to-be-processed task exceeds the computing power range of the first core, determining a target computing power provider, based on the computing power required by the first to-be-processed task, computing power ranges of the N cores, and a computing power range of the electronic device; wherein the computing power required by the first to-be-processed task falls within a computing power range of the target computing power provider, and the target computing power provider is one or more of the N cores and the electronic device; and
processing, through the target computing power provider, the first to-be-processed task.

2. The method as claimed in claim 1, wherein
before determining whether the computing power required by the first to-be-processed task exceeds the computing power range of the first core, the method further comprises:
in a case where the wearable device is powered on, exchanging computing power ranges between the first core and N−1 cores; and
in a case where the computing power range of the first core changes, issuing, by the first core, the computing power range of the first core to the N−1 cores;
wherein the N−1 cores are cores among the N cores except the first core.

3. The method as claimed in claim 1, wherein
before determining whether the computing power required by the first to-be-processed task exceeds the computing power range of the first core, the method further comprises:
in a case where a communication connection is established between the wearable device and the electronic device, issuing the computing power range of the first core to the electronic device or issuing the computing power ranges of the N cores to the electronic device, and obtaining the computing power range of the electronic device issued by the electronic device.

4. The method as claimed in claim 1, wherein
the processing, through the target computing power provider, the first to-be-processed task comprises:
in a case where the number of the target computing power providers is 1, and the target computing power provider is one of the N cores or the electronic device, sending a data processing command and to-be-processed data to the target computing power provider;
wherein the data processing command carries a computing power provider identifier of the target computing power provider and a computing power-identifier of computing power required by the first to-be-processed task;
the computing power provider identifier is configured for verification by the target computing power provider; and, in a case where the verification of the computing power provider identifier is successful, the computing power provider identifier is configured for the target computing power provider to call matched computing power to process, according to the computing power identifier, the to-be-processed data.

5. The method as claimed in claim 1, wherein
the processing, through the target computing power provider, the first to-be-processed task comprises:
in a case where the target computing power providers comprise M computing power providers, and the M computing power providers comprise the first core and M−1 computing power providers, splitting the first to-be-processed task into a first subtask and M−1 subtasks; wherein a computing power required by the first subtask falls within the computing power range of the first core, and computing powers required by the M−1 subtasks respectively fall within the computing power ranges of the M−1 computing power providers, and M is an integer greater than or equal to 2;
processing, by the first core, the first subtask; processing, by a first computing power provider, a second subtask; wherein the first computing power provider is any of the M−1 computing power providers, and a computing power required by the second subtask falls within the computing power range of the first computing power provider.

6. The method as claimed in claim 1, wherein
the processing, through the target computing power provider, the first to-be-processed task comprises:
in a case where the target computing power providers comprise M computing power providers, and the M computing power providers do not comprise the first core, splitting the first to-be-processed task into M subtasks; wherein computing powers required by the M subtasks respectively fall within the computing power ranges of the NI computing power providers; M is an integer greater than or equal to 2;
processing, through a second computing power provider, a third subtask; wherein the second computing power provider is any of the M cores, and a computing power required by the third subtask falls within the computing power range of the second computing power provider.

7. The method as claimed in claim 6, wherein
before splitting the first to-be-processed task into M subtasks, the method further comprises:
determining whether all the NI computing power providers meet task performing requirements;
in a case where priorities of all the M computing power providers meet the task performing requirements, executing the operation of splitting the first to-be-processed task into M subtasks.

8. The method as claimed in claim 7, wherein
after determining whether all the M computing power providers meet the task performing requirements, the method further comprises:
in a case where there are Q computing power providers among the N computing power providers that do not meet the task performing requirements, selecting, from the N cores and the electronic device, a computing power provider that meets the task performing requirements to execute the first to-be-processed task.

9. The method as claimed in claim 1, wherein
the method further comprises:
in a case where the target computing power providers comprise the electronic device, detecting a quality of a connection link between the wearable device and the electronic device;
in a case where the quality of the connection link between the wearable device and the electronic device is greater than a first threshold, executing the operation of processing, through the target computing power provider, the first to-be-processed task.

10. The method as claimed in claim 9, wherein
the method further comprises:
in a case where the quality of the connection link between the wearable device and the electronic device is less than the first threshold, transferring a task assigned to the electronic device to a core with the greatest computing power among the N cores for processing.

11. The method as claimed in claim 1, wherein
the method further comprises:
receiving a processing result of a second to-be-processed task and a total to-be-processed task sent by the electronic device; wherein the total to-be-processed task comprises the first to-be-processed task and the second to-be-processed task; and, the computing power required by the second to-be-processed task falls within the computing power range of the electronic device;
performing merging processing on a processing result of the first to-be-processed task and the processing result of the second to-be-processed task to obtain a processing result of the total to-be-processed task.

12. The method as claimed in claim 1, wherein
the computing power ranges of the N cores do not overlap with each other; and, the computing power range of the electronic device does not overlap with the computing power ranges of the N cores.

13. The method as claimed in claim 1, wherein
the N cores run on P operating systems respectively, wherein P is an integer less than or equal to N, and P is an integer greater than or equal to 2.

14-17. (canceled)

18. A wearable device, comprising a processor and a memory, wherein
the processor comprises N cores, N is an integer greater than or equal to 2, the memory is configured to store a computer program, the computer program comprises program instructions, a first core is configured to call the program instructions to execute a computing power scheduling method, the wearable device establishes a communication connection with an electronic device, the method comprises:
in a case where a first core obtains a first to-be-processed task, determining whether a computing power required b the first sed task the first core, wherein the first core is any of the N cores,
in a case where the computing power required by the first to-be-processed task exceeds the computing power range of the first core, determining a target computing power provider, based on the computing power required by the first to-be-processed task, computing power ranges of the N cores, and a computing power range of the electronic device; wherein the computing power required by the first to-be-processed task falls within a computing power range of the target computing power provider, and the target computing power provider is one or more of the N cores and the electronic device; and
processing through the target computing power provider the first to-be-processed task.

19. A computer-readable storage medium, wherein
the computer-readable storage medium stores a computer program; the computer program comprises program instructions; and, the program instructions, when being executed by a first core, enable the first core to execute a computing power scheduling method applied to a wearable-device, the wearable device comprises N cores, the first core is any of the N cores, N is an integer greater than or equal to 2, the wearable device establishes a communication connection with an electronic device, the method comprises:
in a case where a first core obtains a first to-be-processed task, determining whether a computing power required by the first to-be-processed task exceeds a computing power range of the first core;
in a case where the computing power required by the first to-be-processed task exceeds the computing power range of the first core determining a target computing power provider based on the computing power required by the first to-be-processed task, computing power ranges of the N cores, and a computing power range of the electronic device; wherein the computing power required by the first to-be-processed task falls within a computing power range of the target computing power provider, and the target computing power provider is one or more of the N cores and the electronic device; and
processing through the tar get computing ower provider, the first to-be-processed task.

20. (canceled)

21. The wearable device as claimed in claim 18, wherein
before determining whether the computing power required by the first to-be-processed task exceeds the computing power range of the first core, the method further comprises:
in a case where the wearable device is powered on, exchanging computing power ranges between the first core and N−1 cores; and
in a case where the computing power range of the first core changes, issuing, by the first core, the computing power range of the first core to the N−1 cores;
wherein the N−1 cores are cores among the N cores except the first core.

22. The wearable device as claimed in claim 18, wherein
before determining whether the computing power required by the first to-be-processed task exceeds the computing power range of the first core, the method further comprises:
in a case where a communication connection is established between the wearable device and the electronic device, issuing the computing power range of the first core to the electronic device or issuing the computing power ranges of the N cores to the electronic device, and obtaining the computing power range of the electronic device issued by the electronic device.

23. The wearable device as claimed in claim 18, wherein
the processing, through the target computing power provider, the first to-be-processed task comprises:
in a case where the number of the target computing power providers is 1, and the target computing power provider is one of the N cores or the electronic device, sending a data processing command and to-be-processed data to the target computing power provider;
wherein the data processing command carries a computing power provider identifier of the target computing power provider and a computing power identifier of computing power required by the first to-be-processed task;
the computing power provider identifier is configured for verification by the target computing power provider; and, in a case where the verification of the computing power provider identifier is successful, the computing power provider identifier is configured for the target computing power provider to call matched computing power to process, according to the computing power identifier, the to-be-processed data.

24. The computer-readable storage medium as claimed in claim 19, wherein
before determining whether the computing power required by the first to-be-processed task exceeds the computing power range of the first core, the method further comprises:
in a case where the wearable device is powered on, exchanging computing power ranges between the first core and N−1 cores; and
in a case where the computing power range of the first core changes, issuing, by the first core, the computing power range of the first core to the N−1 cores;
wherein the N−1 cores are cores among the N cores except the first core.

25. The computer-readable storage medium as claimed in claim 19, wherein
before determining whether the computing power required by the first to-be-processed task exceeds the computing power range of the first core, the method further comprises:
in a case where a communication connection is established between the wearable device and the electronic device, issuing the computing power range of the first core to the electronic device or issuing the computing power ranges of the N cores to the electronic device, and obtaining the computing power range of the electronic device issued by the electronic device.
